(19) United States
(12) Patent Application Publication
(10) Pub. No.: US 2012/0212761 A1
(43) Pub. Date: Aug. 23, 2012

(54) IMAGE PROCESSING DEVICE, SCREEN CONTROL METHOD, AND RECORDING MEDIUM

(75) Inventor: Tomohiro KUROYANAGI, Kanagawa (JP)

(73) Assignee: RICOH COMPANY, LTD., Tokyo (JP)

(21) Appl. No.: 13/368,526

(22) Filed: Feb. 8, 2012

(30) Foreign Application Priority Data
Feb. 17, 2011 (JP) 2011-032017

(51) Int. Cl. G06F 3/12

(52) U.S. Cl. 358/1.13

(57) ABSTRACT

An image processing device includes a setting value storage unit which stores setting values to define operations set up as macros of applications of the image processing device, a screen information storage unit which stores screen information of a list screen in which UI components are displayed for calling the applications and for calling the macros, a macro control unit which outputs a request for editing a macro, the setting values of which are stored in the setting value storage unit, and for editing the list screen, the screen information of which is stored in the screen information storage unit, according to the macro edit request, and a screen information managing unit which edits, when the editing of the list screen is requested, a UI component for calling the macro in the list screen according to the macro edit request to update the screen information.

### BACKGROUND OF THE INVENTION

1. Field of the Invention

The present disclosure relates to an image processing device, a screen control method, and a recording medium which are adapted to call a macro function to perform a routine operation.

2. Description of the Related Art

In recent years, a multi-function peripheral (MFP) can register a macro function (also called a macro) for an individual user. A set of routine operation procedures frequently used by an application of the MFP may be registered as a macro function of the application, and the registered macro may be arbitrarily called to perform the routine operation.

For example, the registration of a macro in a multi-function peripheral can be performed as follows. If a user registers a setting value of a specific setting item of a copy application as a macro, the user is allowed to call this macro to perform the copy application in which the registered setting value is set in the setting item. Accordingly, the load of a user's setting operation can be reduced and the operability can be improved.

Japanese Laid-Open Patent Publication No. 2002-132100 discloses a method of presenting to a user an operation screen in which the shortcut icons of respective applications or macros can be arranged collectively.

According to the related art, with respect to registration of a macro, assignment of a macro call function to the existing key is taken into consideration. However, when the shortcut icons for calling macros are arranged in a home screen, interlocking the home screen with the editing of the registered macro, such as registration, deletion and change is not taken into consideration.

For example, it is assumed that a macro “A4 color scanner” is registered in an MFP with a registration number No. 3 and corresponds to a shortcut icon in a home screen. In this case, if the content of this registered macro No. 3 is changed to “A3 black and white (B/W) scanner”, the shortcut icon of the macro No. 3 may be displayed as “A4 color scanner” on the MFP, even after the macro is changed. Depression of the shortcut icon will not be consistent with operation of the MFP intended by the operator, because the changed macro “A3 black and white (B/W) scanner” is actually called and the corresponding operation is performed on the MFP.

### SUMMARY OF THE INVENTION

In one aspect, the present disclosure provides an image processing device, a screen control method, and a recording medium which are capable of making a shortcut icon of a macro displayed in a screen consistent with operation of the macro on the image processing device when the macro is changed.

In an embodiment which solves or reduces one or more of the above-described problems, the present disclosure provides an image processing device including a processor arranged to call a macro from a storage device to perform a routine operation, the storage device including: a setting value storage unit which stores setting values to define operations set up as macros of applications of the image processing device; and a screen information storage unit which stores screen information of a list screen in which UI components are displayed for calling the applications and for calling the macros, and the processor including: a macro control unit to output a request for editing a macro, the setting values of which are stored in the setting value storage unit, and for editing the list screen, the screen information of which is stored in the screen information storage unit, according to the macro edit request; and a screen information managing unit to edit, when the editing of the list screen is requested by the macro control unit, a UI component for calling the macro in the list screen according to the macro edit request to update the screen information.

In an embodiment which solves or reduces one or more of the above-described problems, the present disclosure provides a screen control method for use in an image processing device including a processor arranged to call a macro from a storage device to perform a routine operation, the storage device including a setting value storage unit which stores setting values to define operations set up as macros of applications of the image processing device, and a screen information storage unit which stores screen information of a list screen in which UI components are displayed for calling the applications and for calling the macros, the screen control method including: outputting, by a macro control unit of the processor, a request for editing a macro, the setting values of which are stored in the setting value storage unit, and for editing the list screen, the screen information of which is stored in the screen information storage unit, according to the macro edit request; and editing, by a screen information managing unit of the processor, when the editing of the list screen is requested by the macro control unit, a UI component for calling the macro in the list screen according to the macro edit request to update the screen information.

Other objects, features and advantages of the present disclosure will become more apparent from the following detailed description when read in conjunction with the accompanying drawings.

### BRIEF DESCRIPTION OF THE DRAWINGS

FIG. 1 is a block diagram showing the hardware composition of an MFP of an embodiment of the present disclosure.

FIG. 2 is a block diagram showing the functional composition of the MFP of the present embodiment.

FIG. 3 is a diagram showing an example of a home screen.

FIG. 4 is a diagram showing an example of icon image information.

FIG. 5 is a diagram showing an example of icon arrangement information.

FIG. 6 is a diagram showing an example of setting values of a copy application.

FIG. 7 is a sequence diagram for explaining a process for editing a macro.

FIG. 8 is a diagram showing an example of a macro list screen.

FIG. 9 is a diagram showing an example in which a name of an icon in a home screen is changed.

FIG. 10 is a diagram showing an example in which an icon in a home screen is deleted.

FIG. 11 is a block diagram showing the functional composition of an MFP of an embodiment of the present disclosure.

FIG. 12 is a sequence diagram for explaining a registering process including registration of a publication macro and registration of an icon.

FIG. 13 is a diagram showing an example of a copy macro list screen and a published macro list screen.

FIG. 14 is a diagram showing an example of a case in which a publication macro is used by other users.

FIG. 15 is a diagram showing an example of icon arrangement information of a user-B.

FIG. 16 is a sequence diagram for explaining a process for deleting a publication macro.

FIG. 17 is a diagram showing an example of setting value information of a publication source user and setting value information common to a system.

FIG. 18 is a diagram showing an example of the setting value information of the publication source user after a publication macro is moved to the setting value information common to the system.

FIG. 19 is a diagram showing an example of icon arrangement information of a user.

FIG. 20 is a sequence diagram for explaining a process for changing a publication macro.

FIG. 21 is a diagram showing an example of setting value information of a publication source user and setting value information common to a system.

FIG. 22 is a diagram showing an example of the setting value information of the publication source user after a publication macro is moved and changed and the common setting value information of the system to which the publication macro is moved.

### DETAILED DESCRIPTION OF THE PREFERRED EMBODIMENTS

A description will be given of embodiments of the present disclosure with reference to the accompanying drawings.

In the following, an MFP (multi-function peripheral) will be described as an example of the image processing device of the present disclosure.

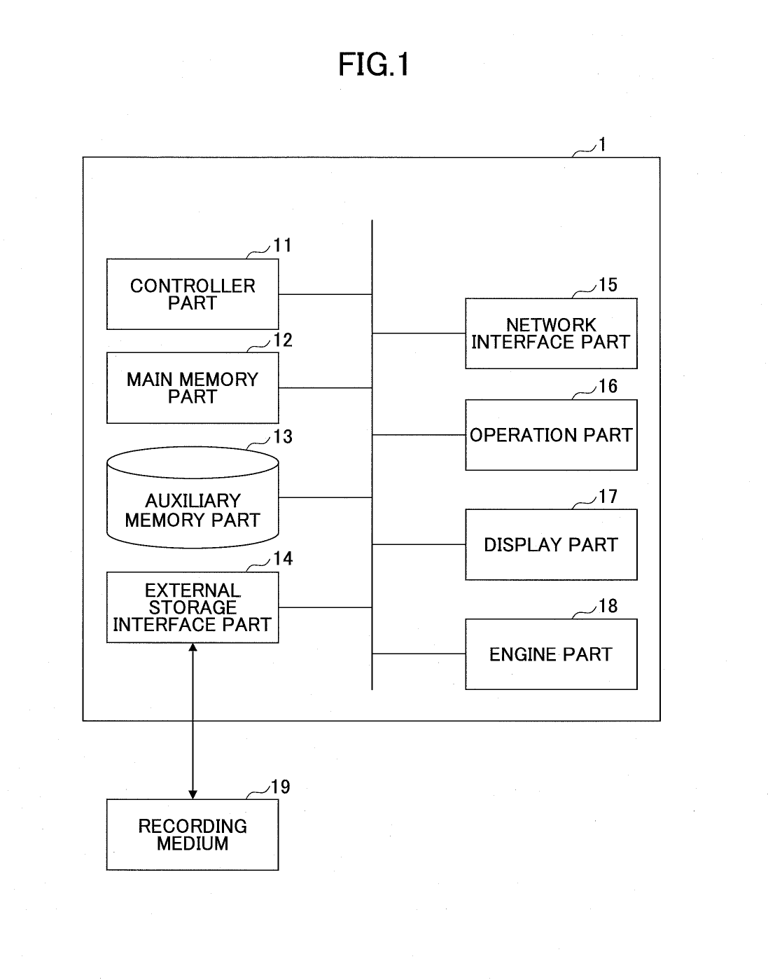

FIG. 1 is a block diagram the hardware composition of an MFP 1 of an embodiment of the present disclosure.

As shown in FIG. 1, the MFP 1 is constructed to include a controller part 11, a main memory part 12, an auxiliary memory part 13, an external storage interface part 14, a network interface part 15, an operation part 16, a display part 17, and an engine part 18. These component parts in the MFP are interconnected by a bus, and, through the bus, transmission and reception of data between two component parts is possible.

The controller part 11 is a CPU (central processing unit) which performs control of each component part in the MFP and performs computation and processing of data in the MFP. The controller part 11 is a processor which executes a program stored in the main memory part 12 or the auxiliary memory part 13. The controller part 11 (or the processor) receives data from an input device or a storage device, computes and processes the data, and outputs the processed data to an output device or a storage device.

The main memory part 12 includes a ROM (read only memory), a RAM (random access memory), etc. The main memory part 12 is a storage device which permanently or temporarily stores the programs including the operating system (OS) as the basic software and application programs executed by the controller part 11, and stores data relevant to the programs.

The auxiliary memory part 13 is a HDD (hard disk drive) or the like. The auxiliary memory part 13 is a storage device which stores data relevant to the application programs, etc.

The external storage interface part 14 is an interface between the MFP 1 and a recording medium 19 (for example, a flash memory, an SD card, etc.) connected to the MFP 1 via a data transmission line, such as USE (universal serial bus). A predetermined program is stored in the recording medium 19, and the stored program of the recording medium 19 may be installed into the MFP 1 through the external storage interface part 14. The installed program is executable on the MFP 1.

The network interface part 15 is an interface between the MFP 1 and a peripheral device having a communication function connected to the MFP 1 via a network which is constructed with wired or wireless data transmission lines, such as a LAN (local area network) or WAN (wide area network).

The operation unit 16 and the display part 17 include key switches (hard keys) and an LCD (liquid crystal display) having a touch-panel function (which includes a software key of GUI (graphical user interface)). The operation unit 16 and the display part 17 are an input device and a display device which act as a UI (user interface) when using a function of the MFP 1.

The engine part 18 is an input/output unit of image data in the MFP 1 and performs reading of image data from a paper document and printing of image data on a copy sheet. The engine part 18 is provided with a scanner engine.

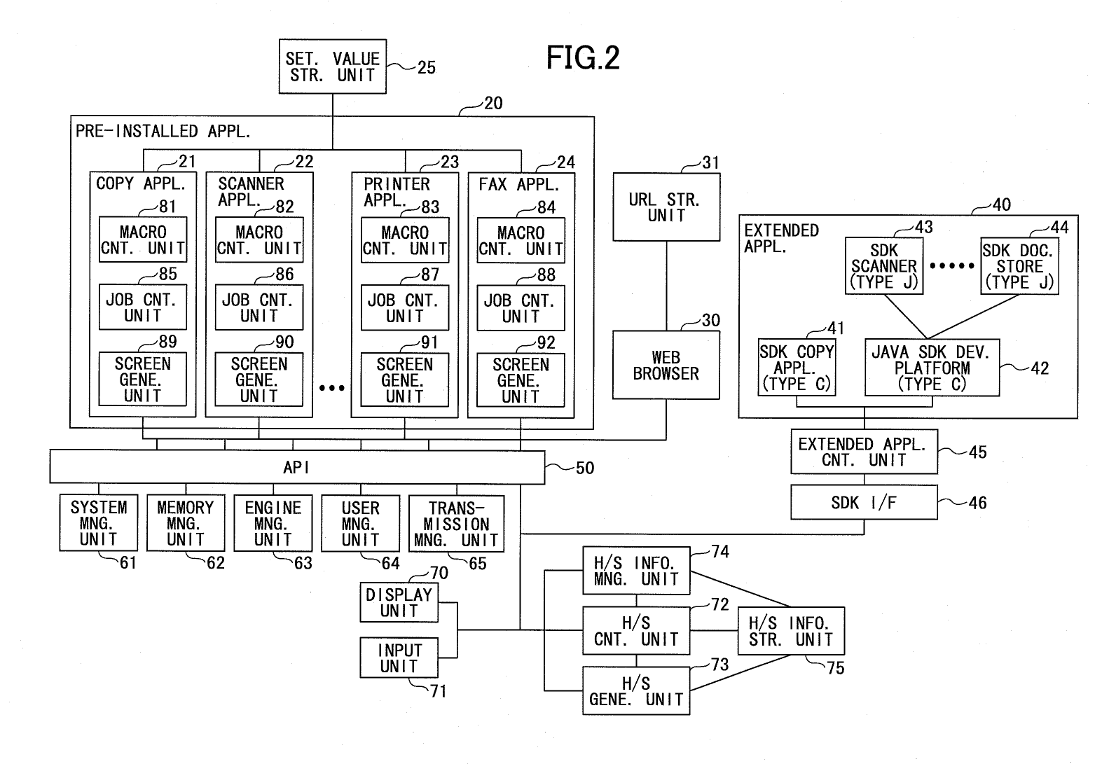

Next, the functional composition of the MFP 1 will be described. FIG. 2 is a block diagram showing the functional composition of the MFP 1 of the present embodiment.

As shown in FIG. 2, the MFP 1 includes pre-installed applications 20, a setting value storage unit 25, a web browser 30, a URL storage unit 31, extended applications 40, an extended application control unit 45, and an SDK (software development kit) interface 46. The MFP 1 includes an API (application programming interface) 50, a system managing unit 61, a memory managing unit 62, an engine managing unit 63, a user managing unit 64, and a transmission managing unit 65. The MFP 1 further includes a display unit 70, an input unit 71, a home screen control unit 72, a home screen generating unit 73, a home screen information managing unit 74, and a home screen information storage unit 75.

The pre-installed applications 20 are standard application programs installed in the MFP 1. For example, a copy application 21, a scanner application 22, a print application 23, and a fax application 24 are included in the pre-installed applications 20. These applications 21-24 include macro control units 81-84, job control units 85-88, and screen generating units 89-92, respectively.

The macro control units 81-84 notify the setting value information of each application to the home screen control unit 72, or edit a macro of each application. Editing of a macro includes registration of the macro, change of each setting value of the macro, deletion of the macro, etc.

The job control units 85-88 control the job performed by each application. The screen generating units 89-92 generate an operation screen of each application, or generate a list of setting values held in each application. Each of the screen generating units 89-92 includes a UI (user interface) to register a shortcut of a macro in a home screen. The pre-installed applications 20 output display data to the display unit 70 using the API 50.

The setting value storage unit 25 stores respective setting values of the pre-installed applications, each of which indicates the operation of a macro with respect to one of the pre-installed applications.

The web browser 30 communicates with a http server and displays a web page on the display part 17. The web browser 30 acquires URL information from the URL storage unit 31 and outputs the web page of the URL information to the display unit 70. The URL storage unit 31 stores URL information displayed by the web browser 30. The web browser 30 is not necessarily a function required for the MFP 1 of the present embodiment.

The extended applications 40 are application programs which can be additionally installed in the MFP 1 by using the SDK (software development kit). Each extended application 40 generates a screen and performs a job of that application. Among the extended applications 40 in the present embodiment, SDK applications developed in C language are referred to as Type C, and SDK applications developed in Java language are referred to as Type J.

An SDK copy application 41 is one of the SDK applications developed in C language. The SDK copy application 41 is classified into the SDK application of Type C (described in C language).

A Java SDK development platform 42 is one of the SDK applications developed in C language. The Java SDK development platform 42 is classified into the SDK application of Type C. The Java SDK development platform 42 is the Java VM (virtual machine) platform for mounting the SDK applications developed in Java language.

An SDK scanner application 43 is one of the SDK applications developed in Java language. The SDK scanner 43 is classified into the SDK application of Type J.

An SDK document storing application 44 is one of the SDK applications developed in Java language. The SDK document storing application 44 is classified into the SDK application of Type J (described in Java language).

The extended application control unit 45 manages the SDK applications. The SDK interface 46 is an interface with the SDK applications (SDK scanner, etc.) for each of the managing units 61-65, the input unit 71 and the display unit 70.

The extended application control unit 45 manages the SDK applications of Type C directly. The extended application control unit 45 uses the Java SDK development platform 42, which is one of the SDK applications of Type C, to mount the SDK applications of Type J on the Java SDK development platform 42.

The system managing unit 61 manages the state of the entire system of the MFP 1. The system managing unit 61 sends a request of displaying an operation screen to each application. The memory managing unit 62 performs memory control and generates data of scanned files. The engine managing unit 63 controls reading of documents. The user managing unit 64 performs management of a user authentication and a scanner transmission destination. The transmission managing unit 65 controls transmission of data from the MFP 1 to an external device via a network.

The display unit 70 displays a home screen or a predetermined screen, for example. A home screen is an application list screen in which a list of icons for calling the respective applications and a list of shortcut icons for calling the macros are displayed. A shortcut icon may also be referred to as an icon. The display unit 70 displays an operation screen of one of the pre-installed applications 20 and the extended applications 40 and a web page provided by the web browser 30.

The input unit 71 detects the depression of an icon in the home screen (the application list screen). An icon is one of the UI components. The input unit 71 receives the depression of an icon as an operation request to the icon. The input unit 71 receives the input operation from the operation screen of one of the pre-installed applications 20 and the extended applications 40, and receives the input operation from the web page screen. The input unit 71 receives an editing operation of each application by a user. The editing operation may be, for example, deletion of a macro, change of a setting value of a macro, registration of a macro, etc.

The home screen control unit 72 determines the screen display owner, in response to the icon of the application list screen from the input unit 71, among the pre-installed applications 20, the extended applications 40 and the web browser 30, and sends a request of displaying the screen to the owner.

The home screen generating unit 73 generates a home screen based on the icon images and the icon arrangement information acquired from the home screen information storage unit 75.

The home screen information managing unit 74 manages the home screen information in the MFP 1, and the management of the home screen information by the home screen information managing unit 74 is interlocked with an editing operation, such as registration, change and deletion of a macro of a corresponding application, by a user.

The home screen information storage unit 75 stores respective icon images which are to be displayed in the home screen, and stores icon arrangement information of each icon image. The icon image information and the icon arrangement information are included in the home screen information.

In the MFP 1, the pre-installed applications 20, the web browser 30, the extended applications 40, the respective managing units 61-65, the home screen control unit 72, the home screen generating unit 73, and the home screen information managing unit 74 may be constituted by the controller part 11, the main memory part 12 functioning as the work memory, and the auxiliary memory part 13 storing the various programs, etc.

The setting value storage unit 25, the URL storage unit 31, and the home screen information storage unit 75 may be constituted by the main memory part 12 and the auxiliary memory part 13. The display unit 70 may be constituted by the display part 17, and the input unit 71 may be constituted by the operation part 16.

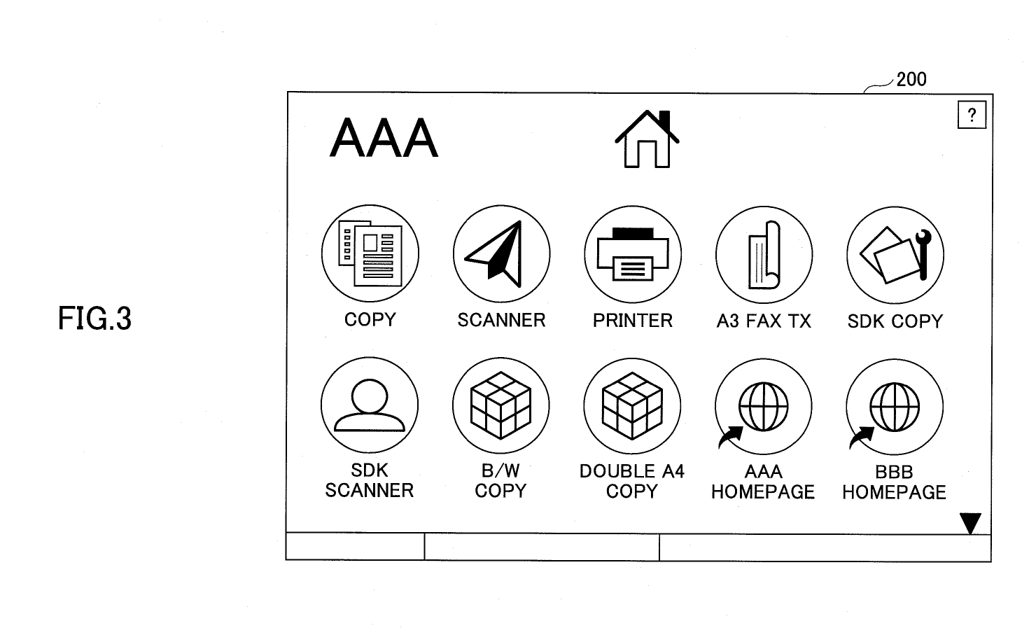

Next, a home screen will be described. FIG. 3 is a diagram showing an example of a home screen.

In the home screen 200 shown in FIG. 3, the icons (copy, scanner, printer) of the pre-installed applications 20, the icons (SDK copy of type C, SDK scanner of type J) of the extended applications 40, the icons (A3 fax transmission setting, black/white copy setting, double-sided copy setting) of the macros of the pre-installed applications 20, and the icons (AAA/BBB home pages) of the URL of the web browser 30 are arranged.

If one of the icons of the home screen of FIG. 3 is depressed, a corresponding application screen, a corresponding web-page screen, or a corresponding application screen with the relevant macro being applied will be displayed. In a case where all the icons to be arranged are not included in a first page of the home screen, if the page skip button (not illustrated) within the home screen is clocked or depressed, the remaining icons to be continued to the following page of the home screen will be displayed.

Next, a data structure of icon image information and icon arrangement information used in the present embodiment will be described.

The home screen information storage unit 75 stores the icon image information and the icon arrangement information.

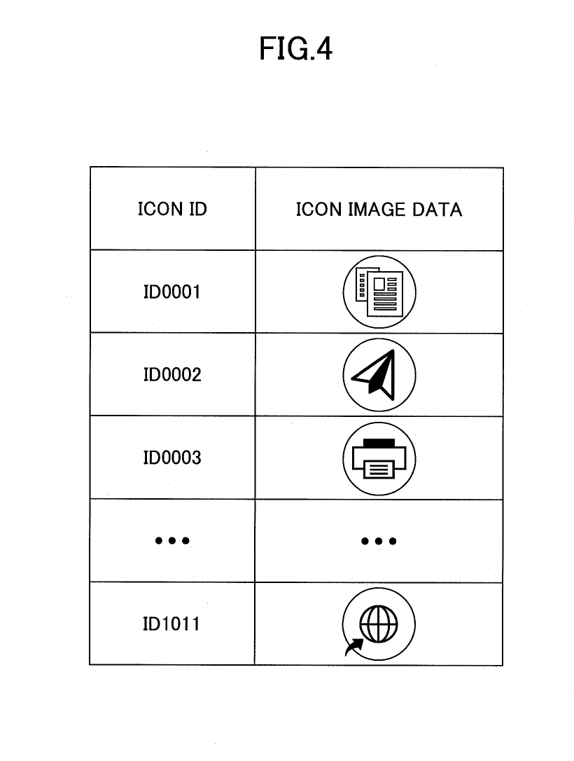

FIG. 4 is a diagram showing an example of the icon image information stored in the storage unit 75. In the icon image information shown in FIG. 4, an icon ID and image data of each icon are associated with each other. The image data of each icon may be previously registered image data or subsequently added image data. For example, when image data of an icon is newly added, a corresponding icon ID associated with the image data is automatically assigned by the home screen control unit 72.

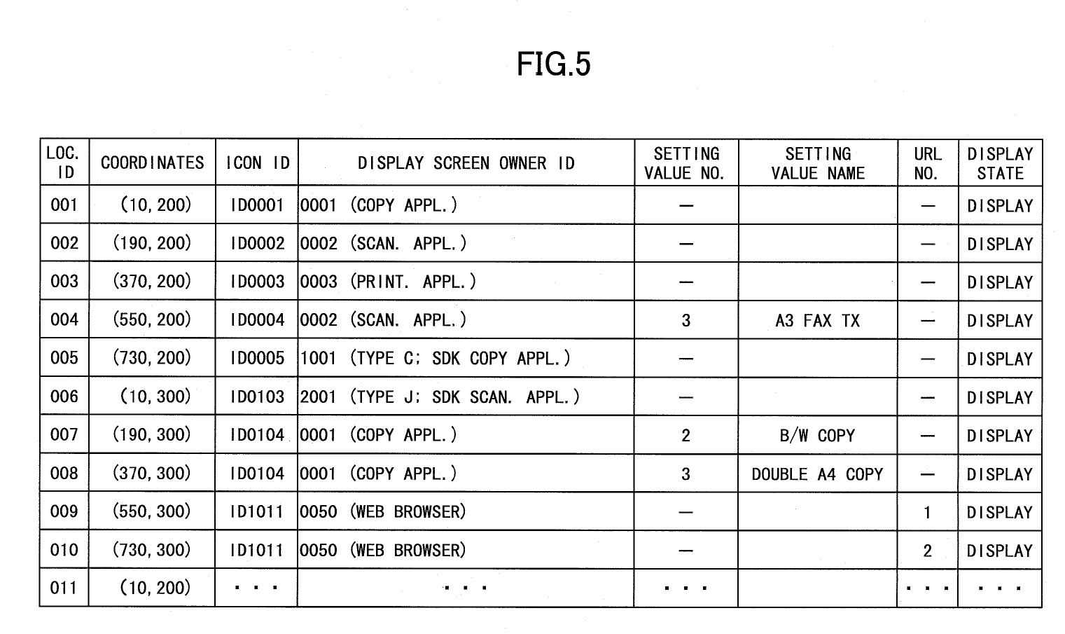

FIG. 5 is a diagram showing an example of the icon arrangement information stored in the storage unit 75. The icon arrangement information shown in FIG. 5 has a data structure in which the coordinates of an icon in a home screen, an icon ID, an icon image corresponding to the icon ID, and a display screen owner ID to identify an owner who displays the home screen, which are associated with a location ID of the icon, are stored. Further, in the data structure of the icon arrangement information of FIG. 5, a setting value number of a macro of the relevant application (if any), a setting value name of the macro (if any), a URL number of the web browser 30, and a displaying state of the icon, which are associated with the location ID of the icon, are stored.

The home screen information managing unit 74 compares the number of icons included in the icon arrangement information with a maximum number of icons which can be arranged within the home screen, and determines whether the number of icons included in the icon arrangement information exceeds the maximum number.

The icon arrangement information has the data structure as shown in FIG. 5 and is stored in the storage unit 75, and the icons of the pre-installed applications 20 and the extended applications 40 are displayed in the same home screen of the MFP 1. For example, the icon of the scanner application 22 among the pre-installed applications 20 with the location ID “4” and the icon of the SDK copy application 41 among the extended applications 40 with the location ID “5” are displayed in the same home screen.

If the setting value numbers of the macros, which are the macros of the same copy application 21, differ from each other, different icons of the macros are displayed. For example, the icon of the macro of the copy application 21 with the location ID “8” differs from the icon of the macro of the copy application 21 with the location ID “7”. As shown in FIG. 5, the setting value number of the former is “3” and the setting value number of the latter is “2”.

Next, setting values of the macros of a pre-installed application 20 stored in the setting value storage unit 25 will be described.

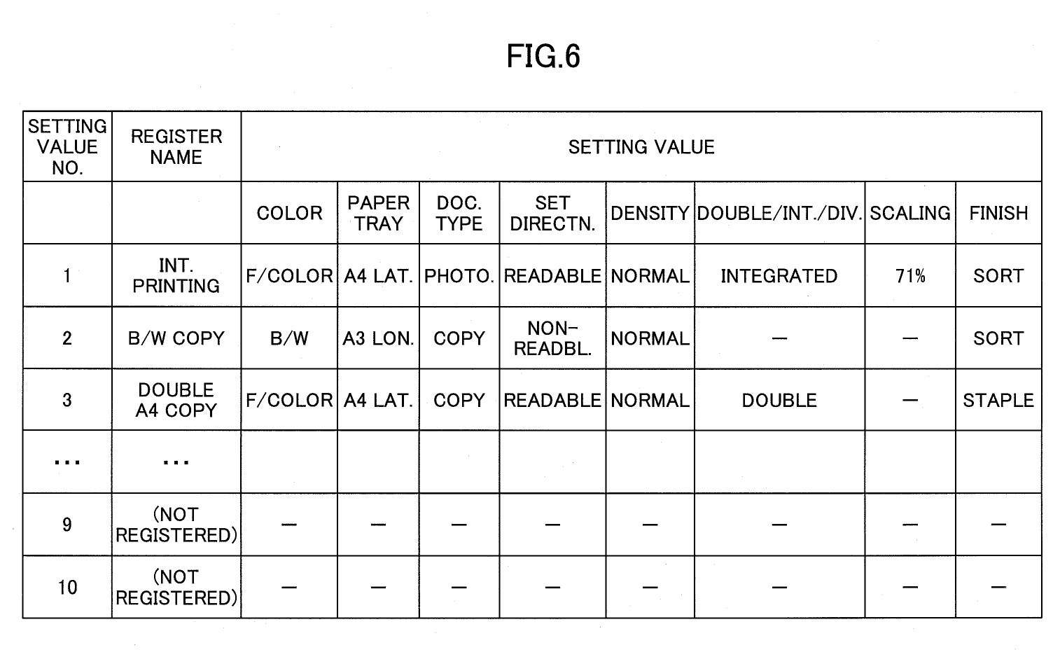

FIG. 6 is a diagram showing an example of the setting value information of the macros of the copy application 21.

As shown in FIG. 6, in the setting value information, for each setting value number of each macro, a registered name and a setting value indicating an operation of the macro are registered beforehand by a user. The setting value number of the macro in the setting value information is associated with that of the icon arrangement information (refer to FIG. 5) of the home screen.

For example, in the setting value information of FIG. 6, for the macro with the setting value number “1”, the registered name is “integrated printing”, the setting value of color is “full color”, the setting value of paper tray is “A4 lateral”, the setting value of document type is “photograph”, the setting value of set direction is “readable direction”, the setting value of print density is “normal”, the setting value of double-sided/integrated/division is “integrated”, the setting value of scaling is “71%”, and the setting value of finish is “sorting”, and these setting values are registered.

Next, an example of an editing process wherein, when a macro is edited, the change to the stored information after the editing is interlocked with the icon displayed in the home screen will be described.

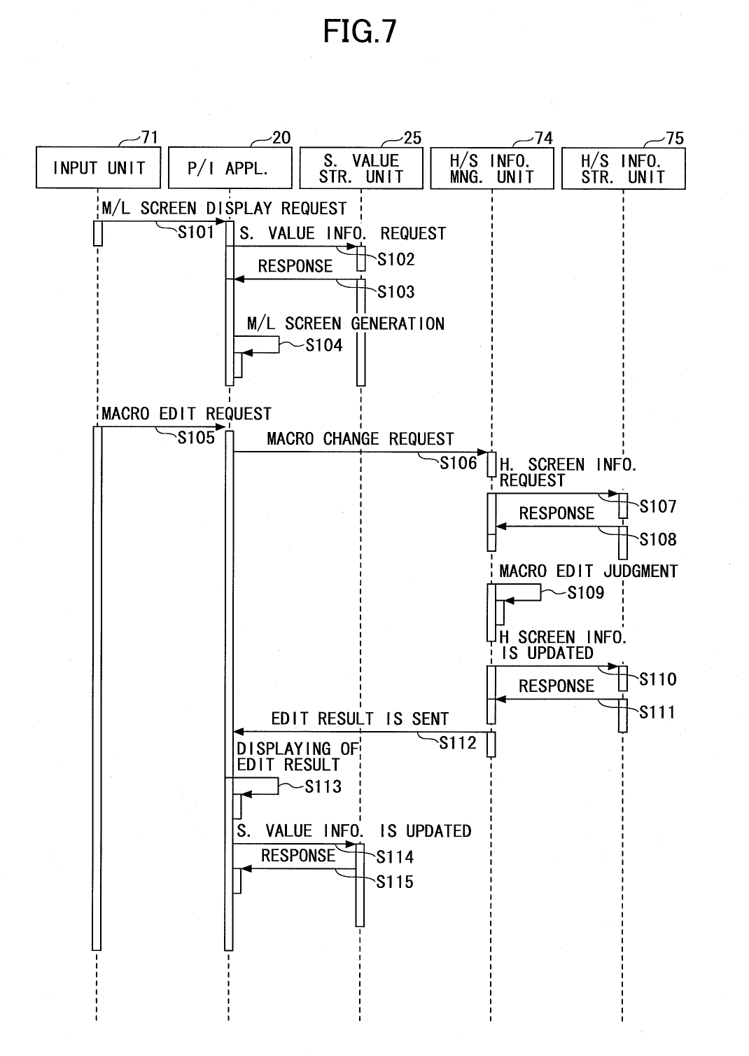

FIG. 7 is a sequence diagram for explaining a process for editing a macro.

At step S101, the input unit 71 receives a request for displaying a macro list screen of a predetermined application from a user, and sends the displaying request of the macro list screen to the pre-installed application 20 (the macro control unit of the predetermined application).

At steps S102 and S103, the pre-installed application 20 (the macro control unit of the predetermined application) acquires the setting value information of the macros of the corresponding application from the setting value storage unit 25.

At step S104, the pre-installed application 20 (the screen generating unit of the predetermined application) generates a macro list screen based on the acquired setting value information. Subsequently, the macro list screen is displayed by the display unit 70.

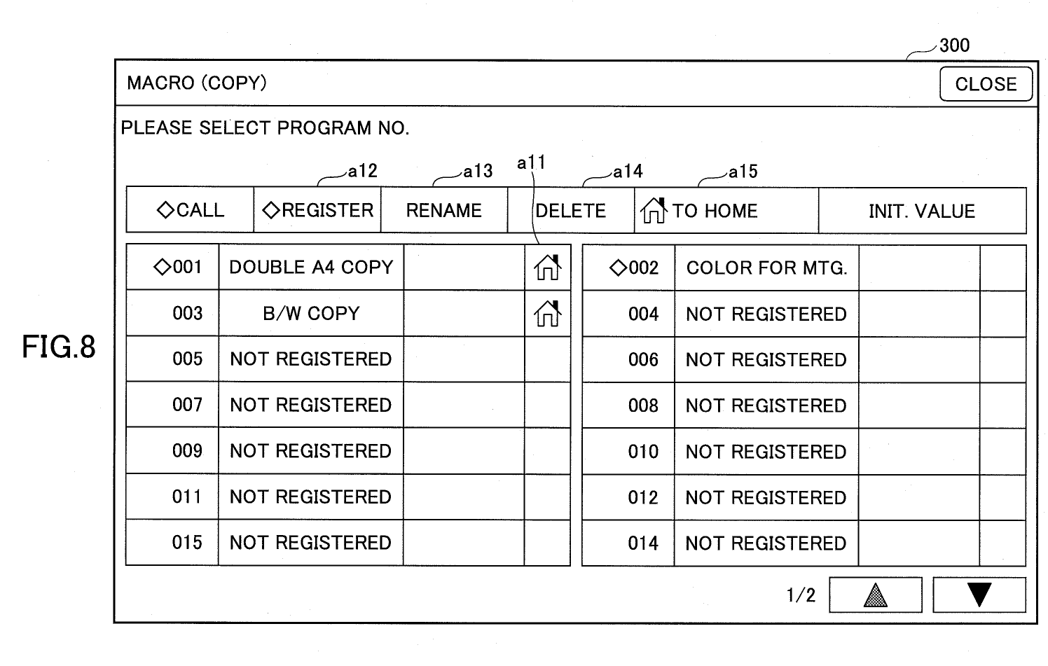

FIG. 8 is a diagram showing an example of a macro list screen.

As shown in FIG. 8, the macro list of the copy application is displayed in a macro list screen 300. In the example shown in FIG. 8, a “double-sided A4 copy” macro is registered for the setting value number “001”, and a “color for meeting” macro is registered for the setting value number “002”. In this macro list screen 300, a home mark “all” indicates that the macro is registered in the home screen information storage unit 75 and its icon is displayed in the home screen. For example, the icon of the “double-sided A4 copy” macro with the setting value number “001” is displayed in the home screen.

Referring back to FIG. 7, at step S105, if editing of a macro of the corresponding application is requested by the user, the input unit 71 sends a request for editing the macro to the pre-installed application 20. For example, it is assumed that this macro edit request is to change the content of the macro with the registered name “double-sided A4 copy” to “single-sided A3 copy” by editing, and to change the registered name of this macro to “single-sided A3 copy” by editing. This macro edit request includes the content of the macro being edited and the setting value number of the macro.

At step S106, the pre-installed application 20 (the macro control unit of the copy application) outputs the setting value number and the content of the macro being edited, which are included in the macro edit request, to the home screen information managing unit 74. For example, the pre-installed application 20 sends to the home screen information managing unit 74 the macro edit request including the setting value number of the “double-sided A4 copy” macro and the information of the changed macro name (“single-sided A3 copy”).

At steps S107 and S108, the home screen information managing unit 74 acquires the home screen information from the home screen information storage unit 75.

At step S109, the home screen information managing unit 74 determines whether to accept the macro edit request based on the number of icons of the acquired home screen information. For example, the home screen information managing unit 74 determines whether the maximum number of icons that can be arranged in the home screen is exceeded after the macro edit request is accepted. If the maximum number is exceeded, the home screen information managing unit 74 does not accept the macro edit request. If the maximum number is not exceeded, the home screen information managing unit 74 accepts the macro edit request.

Alternatively, the determination regarding the maximum number of icons at the step S109 may be performed by the home screen information managing unit 74 only when the macro edit request is a request for registering a new macro.

At steps S110 and S111, the home screen information managing unit 74 updates the home screen information according to the content of the macro edit request. The home screen information being updated at this time is the icon arrangement information included therein. For example, the home screen information managing unit 74 updates the setting value name “double-sided A4 copy” of the macro with the designated setting value number into the new setting value name “single-sided A3 copy”. The home screen information managing unit 74 stores the updated home screen information into the home screen information storage unit 75.

At step S112, the home screen information managing unit 74 notifies the edit result to the pre-installed application 20.

At step S113, the pre-installed application 20 (the screen generating unit) receives the edit result and performs the edit result display processing. For example, the pre-installed application 20 causes the display unit 70 to display an operation screen in a dialog format, indicating that the macro editing has been finished.

At steps S114 and S115, the pre-installed application 20 updates the setting value information according to the content of the edit result. For example, the pre-installed application 20 updates the corresponding setting value name into “single-sided A3 copy”.

In the sequence diagram of FIG. 7, the process for editing a macro has been described as a typical process. Alternatively, the sequence diagram of FIG. 7 in the present embodiment may be modified and applied to any of processes for registering, changing, and deleting a macro in the same manner.

Next, some examples of other macro editing processes will be described.

A user displays the macro list screen 300 shown in FIG. 8 on the display part 17 when the user desires to register a new macro in the MFP 1. The user selects a macro number of the new macro to be registered from the macro list screen 300 of FIG. 8, and depresses the register button a12. Then, the process as shown in FIG. 7 is performed and an icon of the macro is registered into the home screen. The registration of the icon in the home screen is interlocked with the registration of the macro in the MFP 1. The input unit 71 receives such a request from the user.

Specifically, it is assumed that the “not registered” macro column of the setting value number “005” in the macro list screen 300 shown in FIG. 8 is depressed by the user, the respective setting values of A3, color, and staple are set up by using the copy application screen, and the registration of the macro with the macro name “staple” is carried out.

In the above case, the macro “staple” with the setting value number “005” is newly registered in the MFP 1, and, interlocked with this registration process, the icon “staple” is registered in the home screen.

In order to allow the user to determine whether the registration of the icon of the newly registered macro into the home screen is to be performed, a dialog message indicating “whether to register the icon into the home screen” may be displayed at this time. Alternatively, at a subsequent time, after a request for registering the icon in the home screen is received from the user (depression of the “to home” button a15 as shown in FIG. 8), the process of registering the icon of the macro into the home screen may be started.

For example, the home mark all is inserted into the rightmost column on the right-hand side of the corresponding macro column in the macro list screen 300, and this indicates that the icon of the macro with the home mark all is already registered in the home screen. Hence, the icon registration state in the home screen is clearly known from the macro list screen 300.

Next, the process for changing a name of a macro will be described. For example, the process for changing the name of a selected macro is started by depressing the “rename” button a13 in the macro list screen 300 shown in FIG. 8.

Specifically, the name of the macro is changed to the name “single-sided A3 copy” when the content of the macro “double-sided A4 copy” is changed to “single-sided A3 copy”. The home screen information managing unit 74 detects the result of this process and changes the name of the corresponding icon displayed in the home screen.

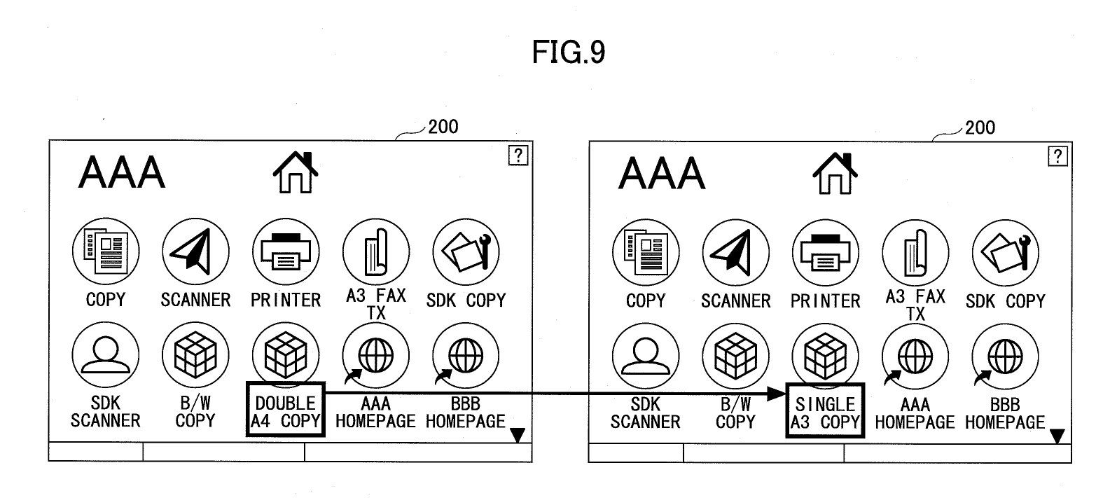

FIG. 9 is a diagram showing an example in which a name of an icon in a home screen 200 is changed. In the example of FIG. 9, when the name of the macro in the pre-installed application 20 is changed, the name of the icon in the home screen 200 is changed accordingly. Specifically, in the example of FIG. 9, the “double-sided A4 copy” icon is changed to the “single-sided A3 copy” icon.

Next, the process for deleting a macro will be described. For example, the process for deleting a selected macro is started by depressing the “delete” button a14 in the macro list screen 300 shown in FIG. 8.

Specifically, when the “double-sided A4 copy” macro is deleted by the process, the home screen information managing unit 74 detects the result of this process and deletes the corresponding “double-sided A4 copy” icon displayed in the home screen.

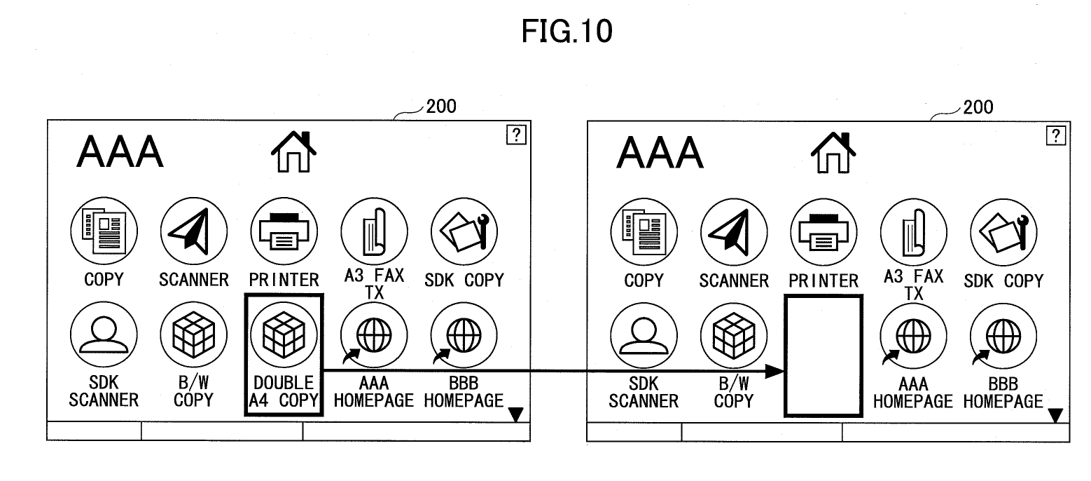

FIG. 10 is a diagram showing an example in which an icon in a home screen 200 is deleted. In the example of FIG. 10, when the macro in the pre-installed application 20 is deleted, the icon in the home screen 200 is deleted accordingly. Specifically, in the example of FIG. 10, the “double-sided A4 copy” icon is deleted.

As described above, according to the foregoing embodiment, the shortcut icon of a macro displayed in the macro list screen can be made consistent with operation of the macro. This is because the macro control unit of the pre-installed application 20 to edit the macro is interlocked with the home screen information managing unit to manage the home screen information of the home screen.

Next, an MFP 2 of another embodiment of the present disclosure will be described. In the present embodiment, the setting value information of a macro is managed for every user. The macro may be shared by multiple users. The hardware composition of the MFP 2 of the present embodiment is essentially the same as that of the previous embodiment, and a description thereof will be omitted.

In the present embodiment, a publication macro is a macro which is published to other users and the right of using the macro is allowed for other users.

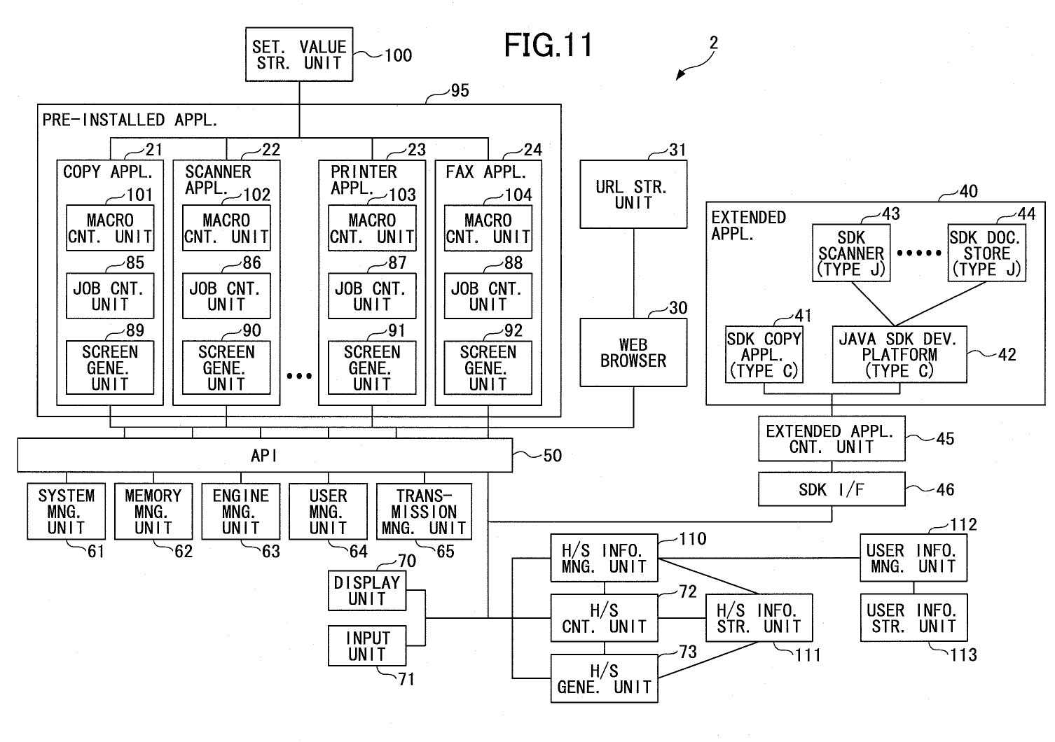

FIG. 11 is a block diagram showing the functional composition of an MFP 2 of the present embodiment. In FIG. 11, the elements which are the same as corresponding elements in FIG. 2 are designated by the same reference numerals, and a description thereof will be omitted.

As shown in FIG. 11, the macro control units 101-104 of the respective applications 21-24 included in the pre-installed applications 95 manage macros for individual users and store the macros set up by the users into the user information storage unit 113.

The setting value storage unit 100 registers the setting values (the system defaults) of the macros of the respective applications of the MFP 2.

The home screen information managing unit 110 manages the home screen information for every user in response to a macro edit request from each of the macro control units 101-104. For example, when a macro edit request from a user is received, the home screen information managing unit 110 acquires the home screen information of the user, who has sent the macro edit request, from the home screen information storage unit 111 and acquires the setting value information of the user from the user information storage unit 113.

The home screen information storage unit 111 stores the home screen information (including the icon arrangement information) for every user.

The user information managing unit 112 manages the setting value information of the macros for every user stored in the user information storage unit 113.

The user information storage unit 113 stores the respective setting values of the macros for every user as the setting value information.

Next, registration of a publication macro in the present embodiment and registration of an icon of the publication macro will be described.

In the following, it is assumed that a user-A registers publication macros and a user-B registers a shortcut icon of the macro No. 3 of the copy application published by the user-A, in the home screen.

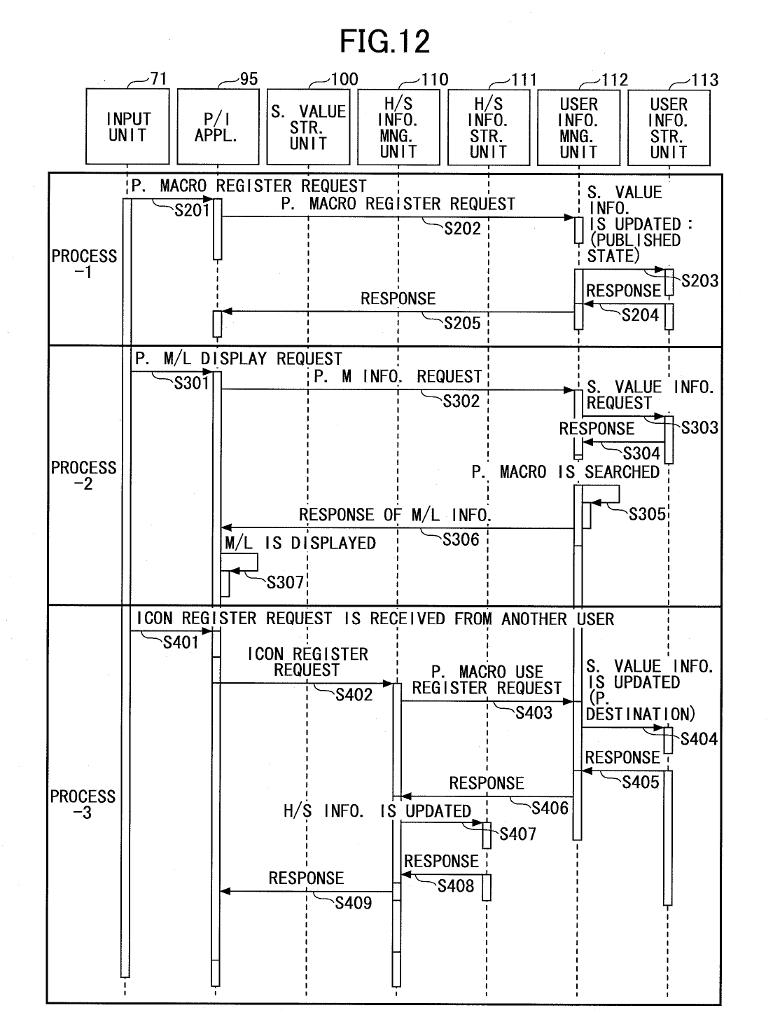

FIG. 12 is a sequence diagram for explaining a registering process including registration of a publication macro (process-1), displaying of a published macro list (process-2), and registration of an icon (process-3).

### Process-1: Registration of Publication Macro

At step S201, the input unit 71 receives, from the user-A, a request of registration of a selected macro No. 3 of the copy application as a publication macro.

At step S202, the pre-installed application 95 sends a request of registration of the publication macro to the user information managing unit 112.

At step S203, the user information managing unit 112 updates the setting value information of the user-A stored in the user information storage unit 113 by setting the copy macro No. 3 in a published state.

At step S204, the user information managing unit 112 receives a response of the end of updating from the user information storage unit 113.

At step S205, the user information managing unit 112 sends a response of the end of registration to the pre-installed application 95.

### Process-2: Displaying of Published Macro List

At step S301, the input unit 71 receives, from the user-A, a request for displaying a published macro (which may also be referred to as the publication macro) list of the copy application.

At step S302, the pre-installed application 95 (the macro control unit) sends a request of acquisition of information of the publication macros to the user information managing unit 112.

At step S303, the user information managing unit 112 sends a request of acquisition of information of the setting value information stored in the user information storage unit 113.

At step S304, the user information managing unit 112 acquires the setting value information from the user information storage unit 113.

At step S305, the user information managing unit 112 searches a publication macro in the setting value information. The information of a publication state is included in the setting value information.

At step S306, the user information managing unit 112 sends a response of the published macro list information to the pre-installed application 95.

At step S307, the pre-installed application 95 causes the display unit 70 to display the searched published macro list.

### Process-3: Registration of Icon

At step S401, the input unit 71 receives a request of registration of an icon through the published macro list from another user (for example, the user-B). The request of registration contains the copy macro No. 3 of the user-B and the user-A.

At step S402, the pre-installed application (the macro control unit) sends a request of registration of an icon to the user information managing unit 112.

At step S403, the home screen information managing unit 110 sends a request of registration of the use of the publication macro by the other user to the user information managing unit 112.

At step S404, the user information managing unit 112 updates the user information stored in the user information storage unit 113 by adding the user-B as a publication destination to the setting value information of the user-A.

At step S405, the user information managing unit 112 receives a response of the end of updating from the user information storage unit 113.

At step S406, the user information managing unit 112 sends a response of the end of updating to the home screen information managing unit 110.

At step S407, the home screen information managing unit 110 sends a request of updating of the home screen information of the other user (the icon arrangement information). For example, the home screen information managing unit 110 updates the home screen information stored in the home screen information storage unit 111 by adding the information indicating the use of the published copy macro No. 3 of the user-A to the home screen information of the user-B.

At step S408, the home screen information managing unit 110 receives a response of the end of updating from the home screen information storage unit 111.

At step S409, the home screen information managing unit 110 sends a response of the end of registration of the icon to the pre-installed application 95.

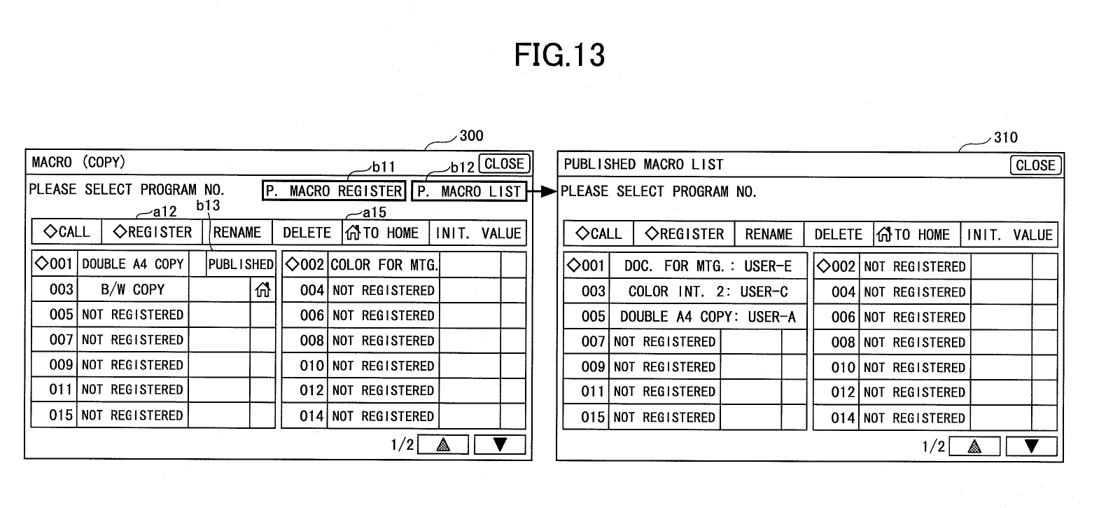

Next, an example of the process shown in FIG. 12 will be described. FIG. 13 is a diagram showing an example of a copy macro list screen and a published macro list screen.

When registering a macro in the macro list screen 300 provided by the copy application, a user may depress the “publication macro register” button b11, as shown in FIG. 13, to register the macro as a macro published to other users, rather than depressing the “register” button a12. Once the macro is registered as a publication macro, it is illustrated in the macro list screen 300 by an icon or character indication b13, indicating that the macro is in a published state.

When the user depresses the “published macro list” button b12 in the macro list screen 300 shown in FIG. 13, the screen 300 is changed to a published macro list screen 310. As shown in FIG. 13, in the screen 310, a macro name of a macro published by each user and a user name of the user as the publication source are displayed.

In the example of FIG. 13, the screen transition from the macro list screen 300 to the published macro list screen 310 is illustrated. Alternatively, the published macro list screen 310 may become present by the screen transition from the home screen or other screens. Further, the displaying of the user name of the user as the publication source in the published macro list screen 310 of FIG. 13 may be canceled.

The registration of a shortcut icon of a publication macro into a home screen may be similarly performed by using the method of registration of the shortcut icon of a macro described above. If the “to home” button a15 in the published macron list 310 as shown in FIG. 13 is depressed after the publication macro to be registered is selected, the shortcut icon of the publication macro can be registered into the home screen.

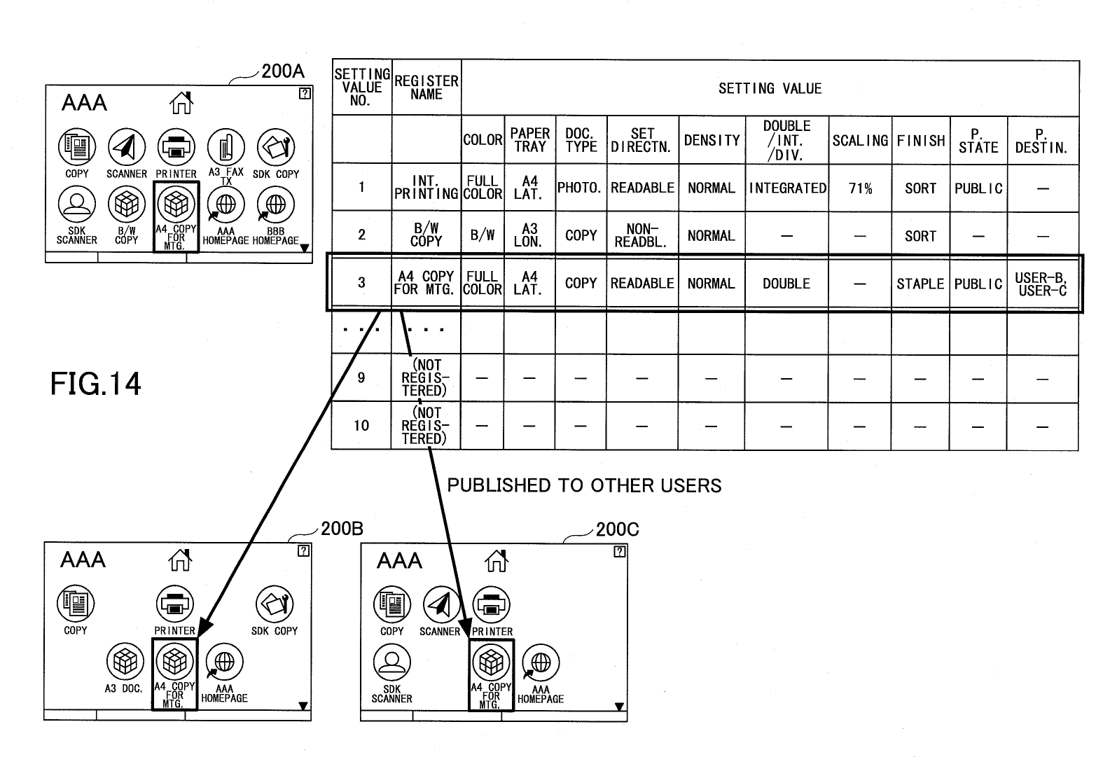

Next, a case in which other users use a publication macro will be described. FIG. 14 is a diagram showing an example of the case in which other users use a publication macro.

In the case of FIG. 14, it is assumed that a user-A has registered the “A4 copy for meeting” macro of the setting value number “3” of the copy application in the home screen 200A as a macro published to other users.

In this case, a user-B and a user-C are able to use the “A4 copy for meeting” macro published by the user-A by registering the shortcut icon of the published macro in their own home screens 200B and 200C as shown in FIG. 14. The setting value information of the user-A is held to include information indicating the published state of each macro (for example, each of the macros of the setting value numbers 1 and 3 in which each macro is published to the other users), and information identifying the publication destination of the other users who use the publication macro (for example, the publication destination of each of the user-B and the user-C).

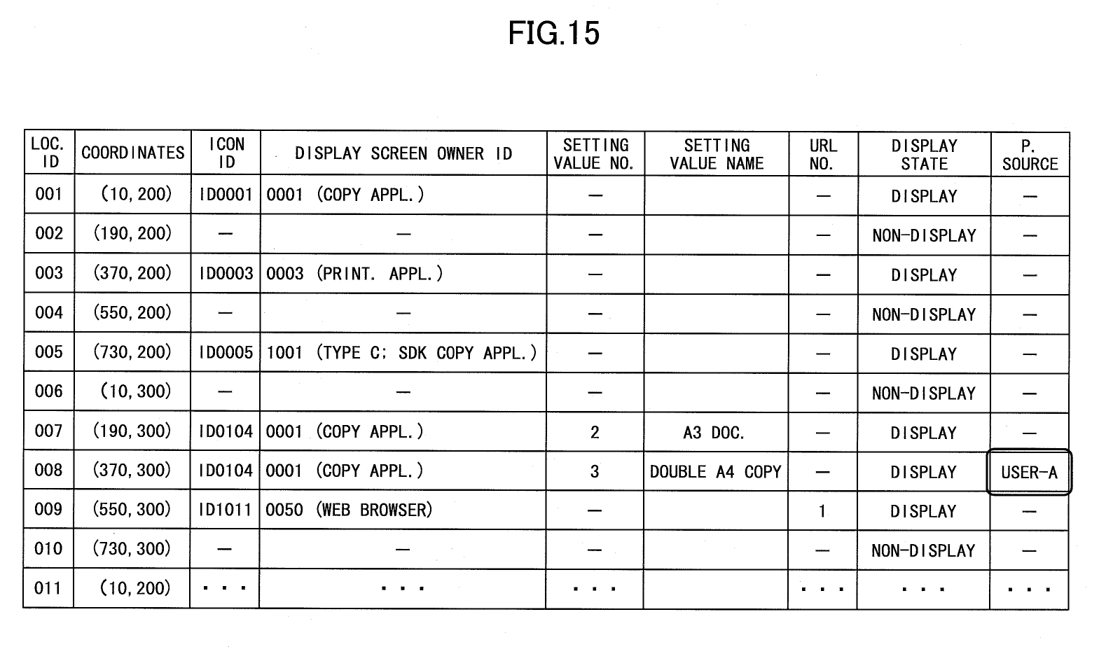

FIG. 15 is a diagram showing an example of the icon arrangement information of the user-B. When the publication macro of the user-A used by the user-B is performed by depressing the shortcut icon of the publication macro of the user-A by the user-B, it is necessary to acquire the setting value information of the macro of the setting value number “3” of the copy application of the user A. As shown in FIG. 15, the icon arrangement information of the user-B is held to include information indicating that the publication source of the publication macro with respect to the required setting value information corresponds to the user-A.

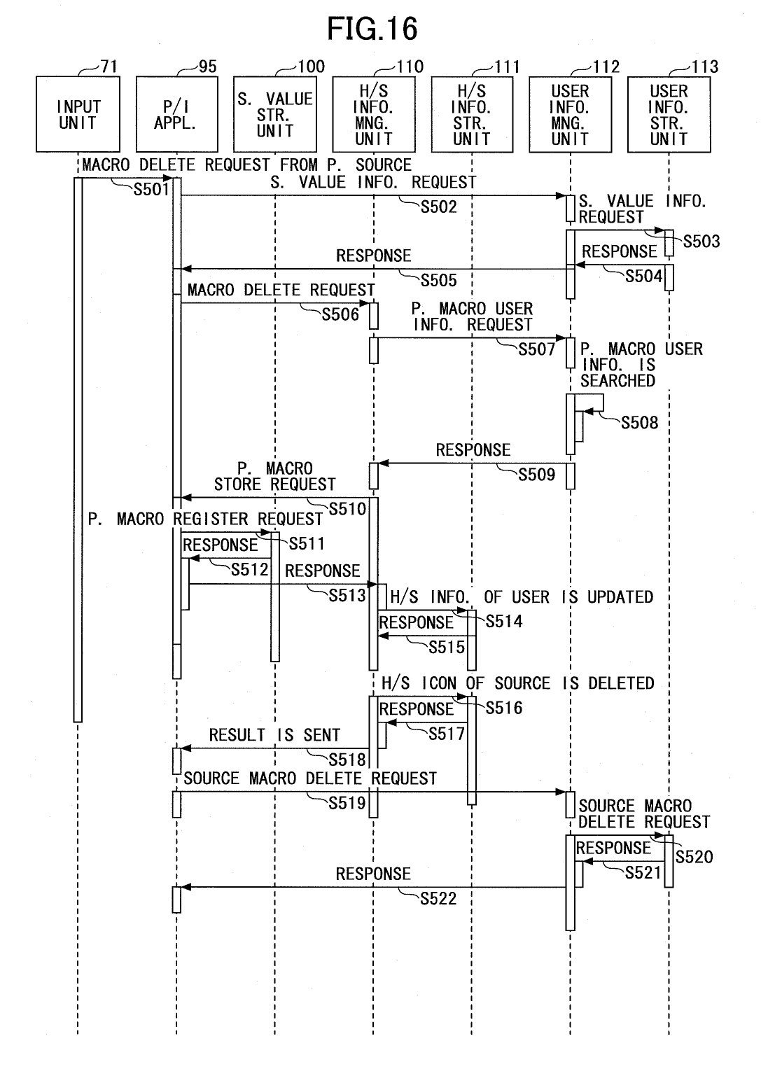

Next, an example of the process for deleting a publication macro will be described. FIG. 16 is a sequence diagram for explaining a process for deleting a publication macro.

At step S501, as shown in FIG. 16, if a deletion request of a macro (publication macro) of a publication source is received from a user, the input unit 71 sends the deletion request of the publication source macro to the pre-installed application 95. The deletion request sent at this time includes a user name and a setting value number of the macro.

At step S502, the pre-installed application 95 sends a request of acquisition of the setting value information to the user information managing unit 112 by designating the user name and the setting value number.

At step S503, the user information managing unit 112 uses the user name and the setting value number designated as a search key and acquires the setting value information from the user information storage unit 113.

At step S504, the user information managing unit 112 receives a response of the end of acquisition of the user information from the user information storage unit 113.

At step S505, the user information managing unit 112 sends a response containing the acquired setting value information to the pre-installed application 95.

At step S506, the pre-installed application 95 (the macro control unit) sends a macro deletion request to the home screen information managing unit 110. The macro deletion request sent at this time includes the user name, the setting value information, and the information of the publication destination.

At step S507, the home screen information managing unit 110 sends a request of acquisition of the user information of the publication macro being deleted to the user information managing unit 112.

At step S508, the user information managing unit 112 searches the user information of the publication macro from the information of the publication destination included in the setting value information being deleted.

At step S509, the user information managing unit 112 sends a response containing the user information of the publication macro to the home screen information managing unit 110.

At step S510, the home screen information managing unit 110 sends a storing request of the publication macro to the pre-installed application 95.

At step S511, the pre-installed application 95 stores the respective setting values of the publication macro being deleted to the setting value information storage unit 100.

At step S512, the pre-installed application 95 receives a response of the end of registration from the setting value information storage unit 100.

At step S513, the pre-installed application (the macro control unit) sends a response of the end of storage of the publication macro to the home screen information managing unit 110.

At step S514, the home screen information managing unit 110 updates the home screen information of the publication macro user. The information of the publication source in the home screen information in this example is changed from “user-A” to “system”. The “system” in this example denotes the setting value information storage unit 100.

At step S515, the home screen information managing unit 110 receives a response of the end of updating from the home screen information storage unit 111.

At step S516, the home screen information managing unit 110 deletes the icon of the publication macro (which is to be deleted from the home screen of the publication source user) in the icon arrangement information stored in the home screen information storage unit 111.

At step S517, the home screen information managing unit 110 receives a response of the end of deletion from the home screen information storage unit 111.

At step S518, the home screen information managing unit 110 notifies a deletion result to the pre-installed application 95.

At step S519, the pre-installed application 95 sends a deletion request of the publication macro of the publication source user to the user information managing unit 112. The deletion request sent at this time includes the setting value number and the user name of the publication source user included.

At step S520, the user information managing unit 112 deletes the publication macro indicated by the setting value number of the publication source user, in the setting value information stored in the user information storage unit 113.

At step S521, the user information managing unit 112 receives a response of the end of deletion from the user information storage unit 113.

At step S522, the user information managing unit 112 sends a response of the end of deletion to the pre-installed application 95.

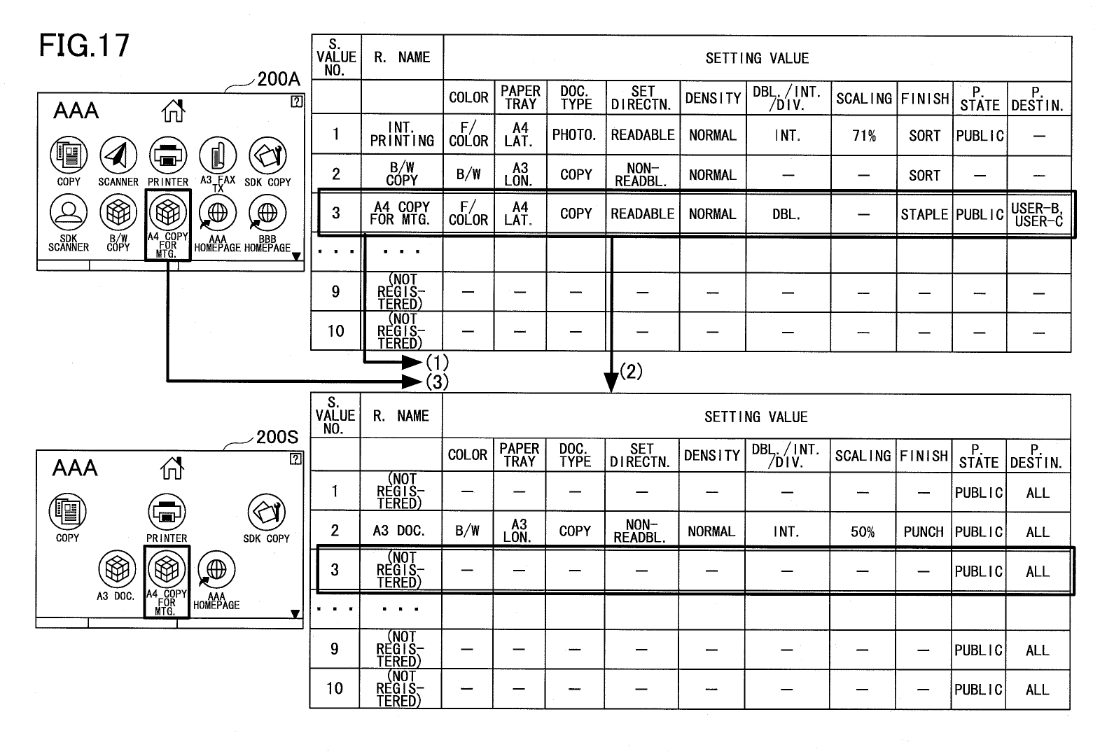

Next, some examples of publication macro deletion will be described with reference to FIGS. 17-19.

FIG. 17 is a diagram showing an example of the setting value information of the publication source user and the setting value information common to the system.

As indicated by (1) in FIG. 17, the user-A (the publication source user) performs the operation to delete the publication macro of the setting value number “3” (corresponding to the step S501).

As indicated by (2) in FIG. 17, the setting values of the publication macro of the setting value number “3” are stored in the setting value information storage unit 100 for the user-B and the user-C who use the publication macro of the setting value number “3” (corresponding to the steps S510 and S511).

As indicated by (3) in FIG. 17, the icon for calling the publication macro of the setting value number “3” is deleted from the home screen in this case (corresponding to the step S516).

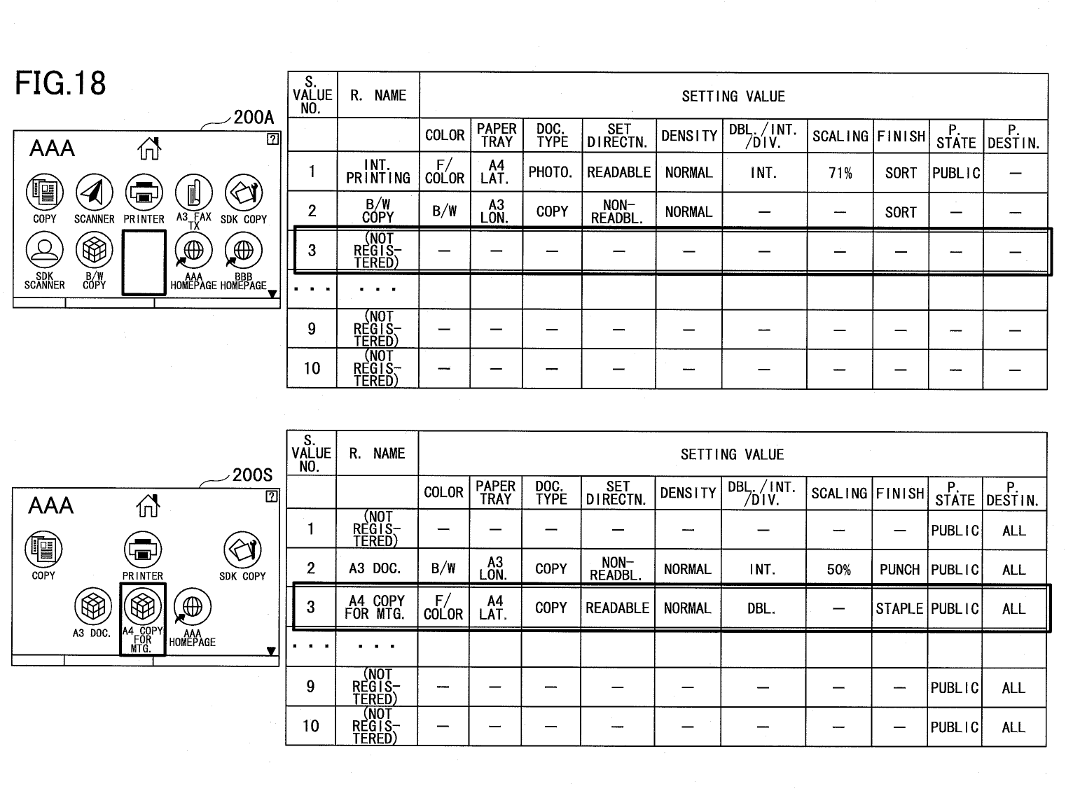

FIG. 18 is a diagram showing an example of the setting value information of the publication source user after the publication macro is moved to the setting value information common to the system.

As shown in FIG. 18, the setting value number “3” of the setting value information of the user-A is set in a “not registered” state. In contrast, the respective setting values of the publication macro of the setting value number “3” of the user-A are registered into the setting value number “3” common to the system.

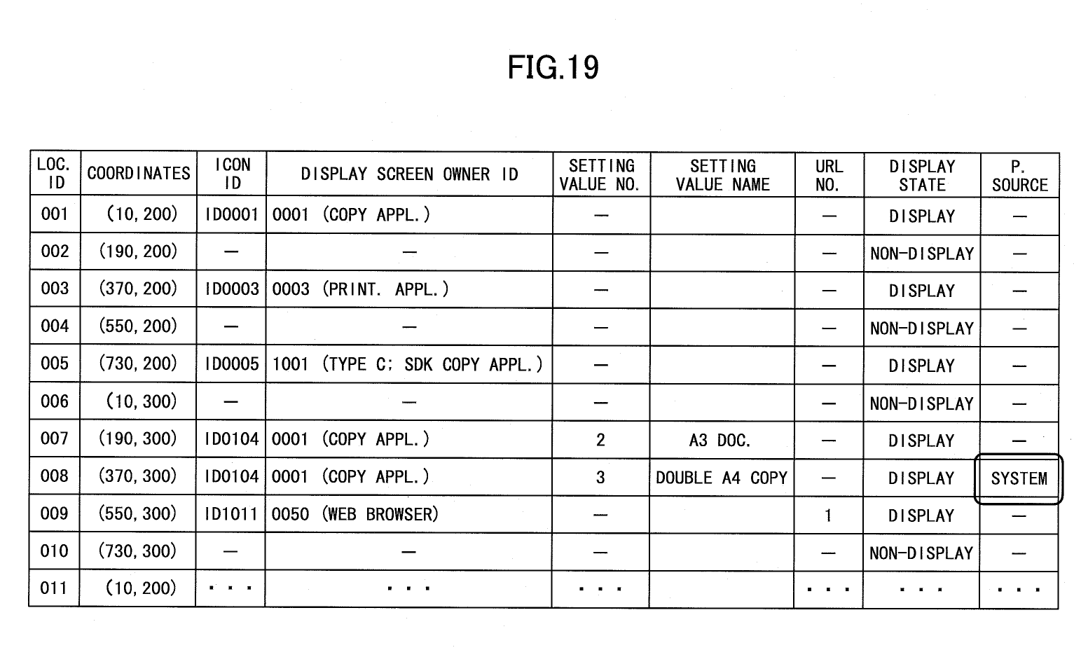

FIG. 19 is a diagram showing an example of the icon arrangement information of a user. In FIG. 19, an example of the icon arrangement information of the user-B is illustrated. The publication source of the macro of the setting value number “3” of the copy application is changed from “user-A” to “system” (corresponding to the step S514). In this case, the setting value number is changed to the setting value number corresponding to the setting value information common to the system. In this case, the setting value number is still “3”.

Accordingly, by changing the information of the publication destination of the icon arrangement information from “user-A” to “system”, the user-B and the user-C can continuously use the publication macro of the setting value number “3” of the user-A even when the publication macro is deleted.

Alternatively, rather than registering the respective setting values of the macro of the publication source as the setting value information common to the system, those values may be registered as the setting value information of the user-B and the user-C.

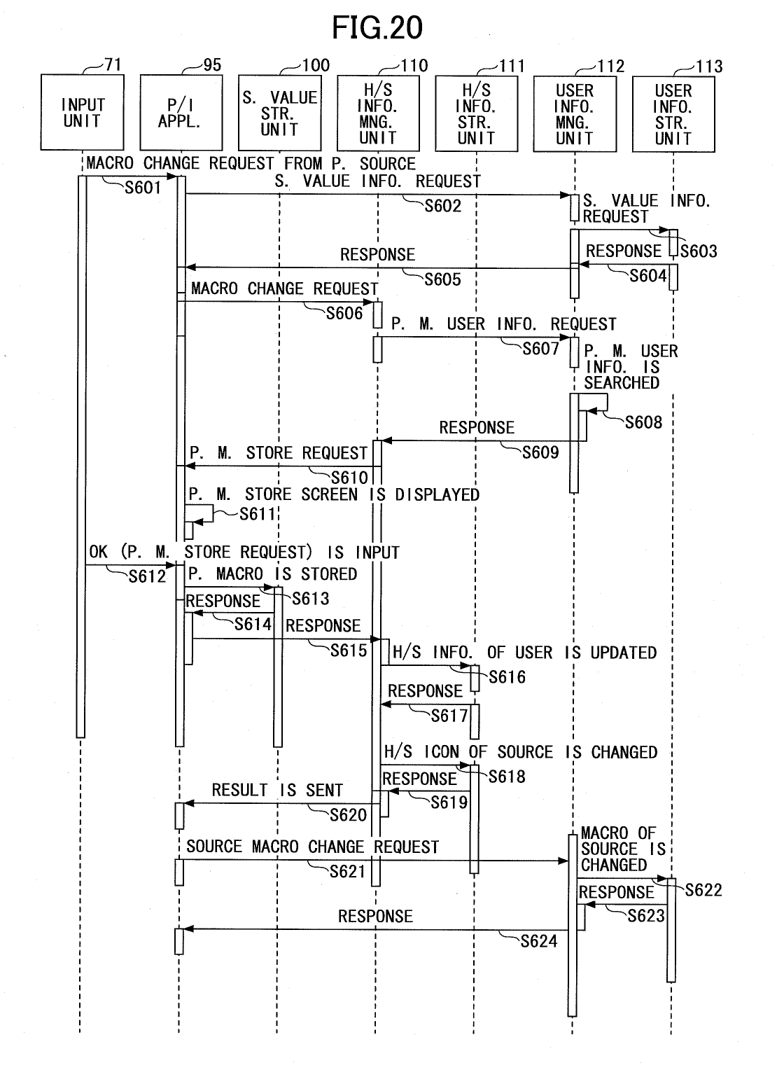

Next, an example of the process for changing a publication macro will be described. FIG. 20 is a sequence diagram for explaining a process for changing a publication macro.

At step S601, as shown in FIG. 20, if a change request of a macro (publication macro) of a publication source is received from a user, the input unit 71 sends the change request of the publication source macro to the pre-installed application 95. The change request sent at this time may include a user name of the publication source, setting value information of a new macro (for example, a new macro name, such as “B/W copy”), and a designated macro setting value number.

At step S602, the pre-installed application 95 sends a request of acquisition of the setting value information to the user information managing unit 112 by designating the user name and the setting value number.

At step S603, the user information managing unit 112 uses the user name and the setting value number designated, as a search key, and acquires the setting value information (including the setting value name “copy for A4 meeting”, the setting value number, etc.) from the user information storage unit 113.

At step S604, the user information managing unit 112 receives a response of the end of acquisition from the user information storage unit 113.

At step S605, the user information managing unit 112 sends a response containing the acquired setting value information to the pre-installed application 95.

At step S606, the pre-installed application (the macro control unit) sends a macro change request to the home screen information managing unit 110. The macro change request sent at this time includes the user name, the setting value information, and the information of the publication destination.

At step S607, the home screen information managing unit 110 sends a request of acquisition of the user information of the publication macro being changed to the user information managing unit 112.

At step S608, the user information managing unit 112 searches the user information of the publication macro from the information of the publication destination included in the setting value information of the publication macro being changed.

At step S609, the user information managing unit 112 sends a response containing the user information of the publication macro to the home screen information managing unit 110.

At step S610, the home screen information managing unit 110 sends a storing request of the publication macro before change to the pre-installed application 95.

At step 611, the pre-installed application 95 generates a confirmation screen indicating whether the user desires to store the setting values of the publication macro before change, and causes the display unit 70 to display the confirmation screen.

At step S612, the input unit 71 receives a response of an input operation from the user to indicate whether the user desires to store the setting values of the publication macro before change. It is assumed in this example that the user response indicates the storage of the setting values of the publication macro before change. The input unit 71 sends the response (indicating the storage of the setting values) to the pre-installed application 95.

At step S613, the pre-installed application 95 stores the setting values of the publication macro before change in the setting value information storage unit 100.

At step S614, the pre-installed application 95 receives a response of the end of registration from the setting value information storage unit 100.

At step S615, the pre-installed application (the macro control unit) sends a response of the end of storage of the publication macro before change to the home screen information managing unit 110.

At step S616, the home screen information managing unit 110 updates the home screen information of the publication macro user. The information of the publication source is changed from the “user name” to the “system”. The “system” in this example denotes the setting value information storage unit 100.

At step S617, the home screen information managing unit 110 receives a response of the end of updating from the home screen information storage unit 111.

At step S618, the home screen information managing unit 110 changes the name (for example, from “A4 copy for meeting” to “single-sided B/W copy”) of the icon of the publication macro included in the home screen information of the publication source user stored the home screen information storage unit 111.

At step S619, the home screen information managing unit 110 receives a response of the end of changing from the home screen information storage unit 111.

At step S620, the home screen information managing unit 110 notifies a change result to the pre-installed application 95.

At step S621, the pre-installed application 95 sends a macro change request of the publication macro of the publication source user to the user information managing unit 112. The macro change request sent at this time includes a setting value number of the macro, a user name of the publication source user, and the contents of the macro changes (a new macro name, changed setting values thereof).

At step S622, the user information managing unit 112 changes the user information including the setting value information based on the contents of macro changes to the publication macro of the publication source user indicated by the setting value number.

At step S623, the user information managing unit 112 receives a response of the end of changing from the user information storage unit 113.

At step S624, the user information managing unit 112 sends a response of the end of changing to the pre-installed application 95.

In the above example, the user is prompted, at the step S612, to provide an input operation to indicate whether the user desires to store the setting values of the publication macro before change, as the macro common to the system. Alternatively, the setting values of the publication macro before change may be stored compulsorily. Alternatively, the publication macro may be changed without compulsorily storing the setting values of the publication macro before change.

When the setting values of the publication macro before change are not stored, the macro changing process in such a modification is essentially the same as the macro editing process of FIG. 7 previously described.

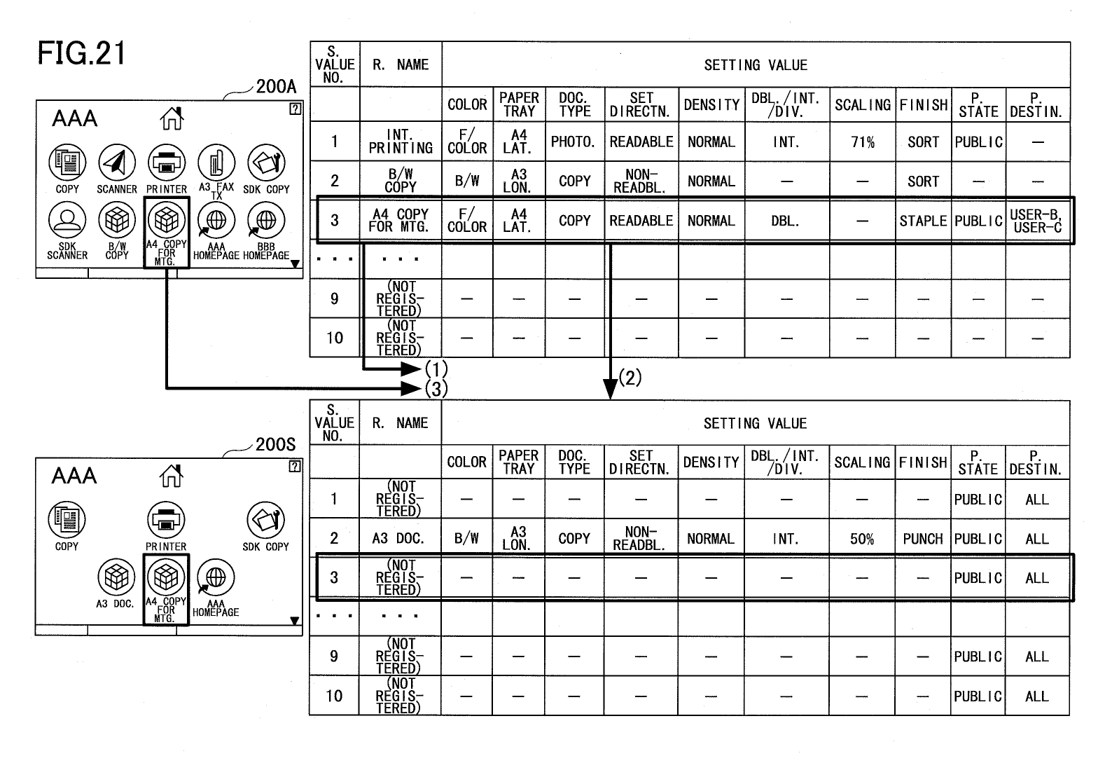

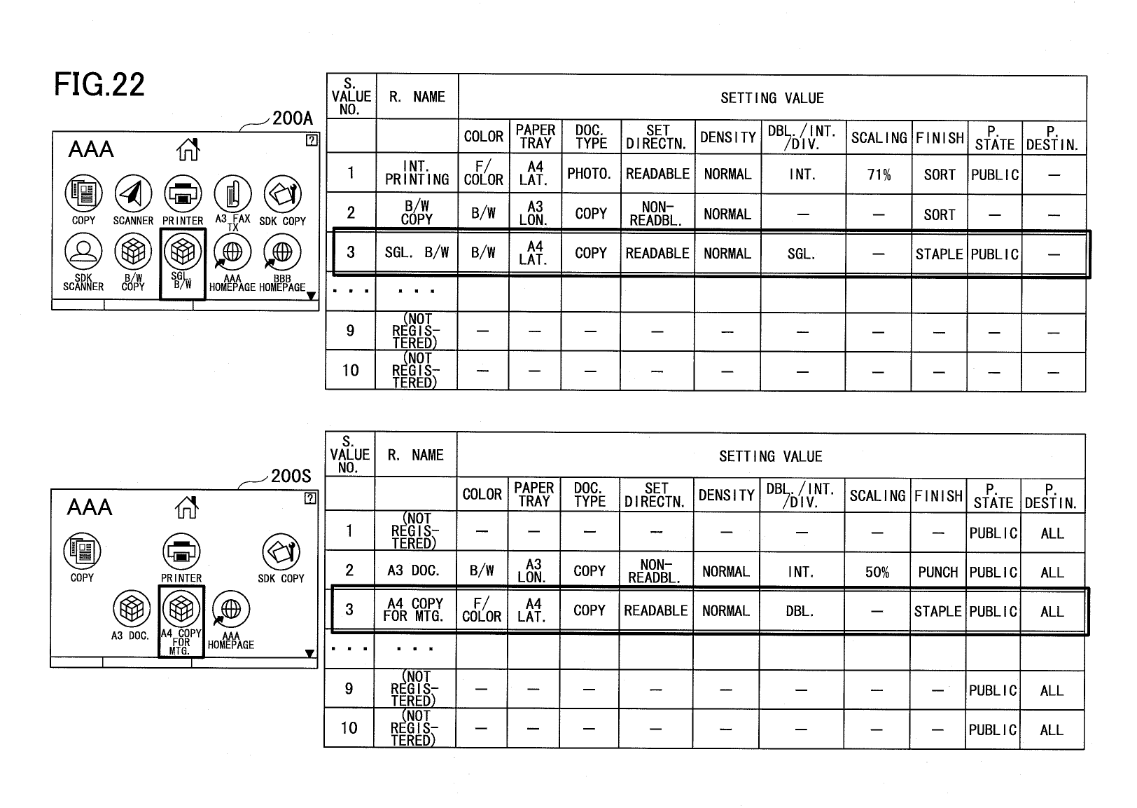

Next, some examples of the macro changing process will be described with reference to FIG. 21 and FIG. 22. FIG. 21 is a diagram showing an example of setting value information of the publication source user and setting value information common to the system.

As indicated by (1) in FIG. 21, the user-A (the publication source user) performs an input operation to change the publication macro of the setting value number “3” (corresponding to the step S601). In this case, it is assumed that the “A4 copy for meeting” macro in the home screen 200A is changed to the “single-sided B/W copy” macro.

As indicated by (2) in FIG. 21, the setting values of the publication macro of the setting value number “3” before change are moved to the setting value information storage unit 100 for the user-B and user-C who use the publication macro of the setting value number “3” (corresponding to the steps S612 and S613).

As indicated by (3) in FIG. 21, in this case, the name of the icon for calling the publication macro “A4 copy for meeting” of the setting value number “3” in the home screen 200A is changed to the new name (corresponding to the step S618).

FIG. 22 is a diagram showing an example of the setting value information of the opening to the publication source user after evacuating the publication macro before change, and the setting value information common to the system.

As shown in FIG. 22, the setting value number “3” of the setting value information of the user-A in the home screen 200A is changed to the “single-sided B/W copy” macro. In contrast, the setting values of the publication macro of the setting value number “3” of the user-A before change are registered into the macro of the setting value number “3” common to the system for the home screen 200S.

The “A4 copy for meeting” macro is registered into the macro common to the system holding the publication macro before change, and the shortcut icon thereof common to the system is also registered in the home screen 200S.

The icon arrangement information of the publication macro user is essentially the same as the icon arrangement information shown in FIG. 19, and the publication source information thereof is changed to the “system”.

Accordingly, with respect to the users of the publication macro, the publication source in the icon arrangement information of each home screen is updated, and the icon of the home screen can be continuously used by reading the setting value information common to the system.

Alternatively, rather than registering the macro of the publication source as the setting value information common to the system, the macro of the publication source may be registered as the setting value information of the user (for example, the user-B). Alternatively, when the publication macro is changed, the setting values of the macro may be changed compulsorily without storing the setting values to the system.

The program to be executed by the image processing device of each of the foregoing embodiments to carry out the above-described processes may be recorded in a non-transitory computer-readable recording medium in an installable or executable file format, such as a CD-ROM (compact disk read-only memory), an FD (flexible disk), a CD-R (compact disk recordable), or a DVD (digital versatile disk), and the recording medium in which the program is recorded may be distributed.

The program to be executed by the image processing device of each of the foregoing embodiments to carry out the above-described processes may be stored in a computer connected to a network, such as the Internet, and the program may be distributed from the computer to another image processing device via the network, such as the Internet. Alternatively, the program may be incorporated beforehand in the ROM of the image processing device.

The program executed by the image processing device of each of the foregoing embodiments may be configured to have the functional composition of FIG. 2 or FIG. 11 described above, and when the controller part 11 (processor) reads out and executes the program from the auxiliary memory part 13, one or more of the respective units of the functional composition of FIG. 2 or FIG. 11 are loaded on the main memory part 12 and the above-described processes are performed by the one or more units of the functional composition of FIG. 2 or FIG. 11 loaded on the main memory part 12.

As described in the foregoing, according to the present disclosure, a shortcut icon of a macro displayed in a screen and operation of the macro on the image processing device can be made consistent with each other when the macro is changed.

The present disclosure is not limited to the specifically disclosed embodiments, and variations and modifications may be made without departing from the scope of the present disclosure.

The present application is based upon and claims the benefit of priority of Japanese patent application No. 2011-032017, filed on Feb. 17, 2011, the contents of which are incorporated herein by reference in their entirety.

What is claimed is:

1. An image processing device including a processor arranged to call a macro from a storage device to perform a routine operation, the storage device comprising:
a setting value storage unit which stores setting values to define operations set up as macros of applications of the image processing device; and
a screen information storage unit which stores screen information of a list screen in which UI components are displayed for calling the applications and for calling the macros, and the processor comprising:
a macro control unit to output a request for editing a macro, the setting values of which are stored in the setting value storage unit, and for editing the list screen, the screen information of which is stored in the screen information storage unit, according to the macro edit request; and
a screen information managing unit to edit, when the editing of the list screen is requested by the macro control unit, a UI component for calling the macro in the list screen according to the macro edit request to update the screen information.

2. The image processing device according to claim 1, wherein the macro control unit is configured to output, when registering a new macro, a request for registering a UI component of the new macro in the screen information of the list screen, and
the screen information managing unit is configured to register, when registration of the UI component of the new macro is requested by the macro control unit, the UI component of the new macro into the list screen according to the macro registering request to update the screen information.

3. The image processing device according to claim 1, wherein the macro control unit is configured to output, when renaming a macro, a request for renaming a UI component of the macro, and
the screen information managing unit is configured to rename, when renaming of the UI component of the macro is requested by the macro control unit, the UI component of the macro in the list screen according to the macro renaming request to update the screen information.

4. The image processing device according to claim 1, wherein the macro control unit is configured to output, when deleting a macro, a request for deleting a UI component of the macro in the list screen, and
the screen information managing unit is configured to delete, when deletion of the UI component of the macro is requested by the macro control unit, the UI component of the macro in the list screen according the macro deleting request to update the screen information.

5. The image processing device according to claim 1, wherein the storage device further includes a user information storage unit which stores setting values of macros published to other users for a user, the setting value storage unit is configured to store setting values of common macros, and the screen information storage unit is configured to store screen information of a list screen including UI components of the published macros for the user,
the macro control unit is configured to output, when editing a macro published to the other users, a request for editing said list screen including a UI component of said macro according to the macro edit request, and
the screen information managing unit is configured to edit, when the editing of said list screen is requested by the macro control unit, the UI component of said macro in said list screen according to the macro edit request to update the screen information of said list screen.

6. The image processing device according to claim 5, wherein the macro control unit is configured to output, when deleting a macro published to the other users, a request for deleting a UI component of said macro in a list screen including the UI component of said macro for a requesting user, and
the screen information managing unit is configured to acquire, when deletion of the UI component of said macro is requested by the macro control unit, setting values of said macro from the user information storage unit to store the setting values of said macro into the setting value storage unit, and configured to delete the UI component of said macro in the list screen of the requesting user to update screen information of the requesting user and delete said macro in the user information storage unit.

7. The image processing device according to claim 5, wherein the macro control unit is configured to output, when changing a macro published to the other users, a request for changing a UI component of said macro in a list screen including the UI component of said macro for a requesting user, and
the screen information managing unit is configured to store, when change of the UI component of said macro is requested by the macro control unit, setting values of said macro of the requesting user before change in the user information storage unit into the setting value storage unit as setting values of the requesting user, and configured to change the UI component of said macro in said list screen of the requesting user to update screen information of the requesting user, so that the setting values of said macro of the requesting user stored in the user information storage unit are changed.

8. A screen control method for use in an image processing device including a processor arranged to call a macro from a storage device to perform a routine operation, the storage device including a setting value storage unit which stores setting values to define operations set up as macros of applications of the image processing device, and a screen information storage unit which stores screen information of a list screen in which UI components are displayed for calling the applications and for calling the macros, the screen control method comprising:
outputting, by a macro control unit of the processor, a request for editing a macro, the setting values of which are stored in the setting value storage unit, and for editing the list screen, the screen information of which is stored in the screen information storage unit, according to the macro edit request; and
editing, by a screen information managing unit of the processor, when the editing of the list screen is requested by the macro control unit, a UI component for calling the macro in the list screen according to the macro edit request to update the screen information.

9. A non-transitory computer-readable recording medium storing a program which, when executed by a computer, causes the computer to perform a screen control method for use in an image processing device including a processor arranged to call a macro from a storage device to perform a routine operation, the storage device including a setting value storage unit which stores setting values to define operations set up as macros of applications of the image processing device, and a screen information storage unit which stores screen information of a list screen in which UI components are displayed for calling the applications and for calling the macros, the screen control method comprising:
outputting, by a macro control unit of the processor, a request for editing a macro, the setting values of which are stored in the setting value storage unit, and for editing the list screen, the screen information of which is stored in the screen information storage unit, according to the macro edit request; and
editing, by a screen information managing unit of the processor, when the editing of the list screen is requested by the macro control unit, a UI component for calling the macro in the list screen according to the macro edit request to update the screen information.
